(19) United States
(12) Patent Application Publication
(10) Pub. No.: US 2008/0212596 A1
(43) Pub. Date: Sep. 4, 2008

(54) Method For Gate Controlling A Media Gateway

(75) Inventor: Yangbo Lin, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/118,820

(22) Filed: May 12, 2008

Related U.S. Application Data
(63) Continuation of application No. PCT/CN2006/002921, filed on Oct. 31, 2006.

(30) Foreign Application Priority Data
Nov. 11, 2005 (CN) 200510101136.2

(51) Int. Cl. H04L 12/56

(52) U.S. Cl. 370/401

(57) ABSTRACT

A method for gate controlling a media gateway mainly includes the following: the media gateway receives gate control information for gate controlling media streams of the media gateway from a media gateway controller; and the media gateway performs gate control to the media streams passing through the media gateway according to the gate control information.

### CROSS-REFERENCE TO RELATED APPLICATIONS

This application is a continuation of International Application No. PCT/CN2006/002921, filed Oct. 31, 2006. This application claims the benefit of Chinese Application No. 200510101136.2, filed Nov. 11, 2005. The disclosures of the above applications are incorporated herein by reference.

### FIELD

The present disclosure relates to the field of communications technology and to the control technology of the media gateway.

### BACKGROUND

The statements in this section merely provide background information related to the present disclosure and may not constitute prior art.

In the next generation network (NGN), demand for the separation of controlling and bearing in the network results directly in the development of the control technology of the media gateway. Referring to FIG. 1, which is the schematic diagram of media gateway control in the prior art, devices for the media gateway control in the NGN primarily include the media gateway controller (MGC) and the media gateway (MG); the MGC deals with the function of call controlling and the MG deals with the function of service bearing, so as to realize the separation of the call controlling plane and the service bearing plane, thus completely sharing network resources, simplifying device upgrade and service extension, and significantly cutting the cost for development and maintenance.

The media gateway control protocol is the major protocol for communication between the MG and the MGC, and two protocols are now widely used: H.248/MeGaCo (Gateway Control Protocol) and MGCP (Media Gateway Control Protocol), among which the MGCP protocol version 1 was instituted in Oct. 1999 by IETF and revised in January 2003, the H.248/MeGaCo protocol version 1 was instituted in November 2000 by IETF and ITU cooperatively and revised in June 2003, the H.248 protocol version 2 was instituted in May 2002 by ITU and revised in March 2004, and the H.248 protocol version 3 was instituted in July 2005 by ITU and is yet to be published.

Taking the H.248 protocol as an example, various resources on the MG are abstractively expressed as the Termination. The Termination is further classified into Physical Termination and Ephemeral Termination, with the Physical Termination representing some semi-permanent existing physical entities such as the TDM channel, etc., and the Ephemeral Termination representing some public resources which are applied temporarily and released after being used, such as the RTP stream, etc. Combinations among the Terminations are abstractively expressed as the Context. The Context may include multiple Terminations, and the inter-relationship between the Terminations is described by Topology. As to the Termination which has no relations with other Terminations yet, it may be included in a special context called Null Context.

Referring to FIG. 2, under the control of MGC, MG is in charge of the conversion and transfer of the media stream between the user and the packet-based network as well as between the packet-based network of different domains. In the specific application, the access media gateway may perform the conversion and transfer of the media between the POTS users and the RTP stream; the trunk media gateway may perform the conversion and transfer of the media between the TDM relay and the RTP stream; and the packet media gateway may perform the conversion and transfer of the media between the RTP streams.

Generally, in the aforementioned packet-based network, any one of the media streams between the MGs has such fundamental features as the source address, source port, destination address, destination port and protocol type. In consideration of quality of service and security, it is necessary to control the media stream passing through MG. For example, it is necessary to enable or disable the reception of the importing media streams from the designated source address and port. For another example, it is necessary to enable or disable the exporting media streams sent from the designated source address and port. In other words, it is necessary to perform gate control to the media stream received and sent by the MG.

### SUMMARY

The disclosure provides, in various embodiments, a gate control method of the media gateway, including:

receiving, gate control information for gate controlling media streams of a media gateway from a media gateway controller;

performing gate control to the media streams passing through the media gateway according to the gate control information.

The gate control information includes a media stream filtering rule for performing gate control to the media streams passing through the media gateway, a media stream source/destination address, and a source/destination port and protocol type information needed when performing filtering according to the media stream filtering rule.

The media stream filtering rule includes a media gateway importing direction media stream filtering rule and/or a media gateway exporting direction media stream filtering rule.

The media gateway importing direction media stream filtering rule comprises at least one of the following rules:

enabling or disabling filtering of the importing direction media streams according to the source address;

enabling or disabling filtering of the importing direction media streams according to the source port;

enabling or disabling filtering of the importing direction media streams according to the destination address;

enabling or disabling filtering of the importing direction media streams according to the destination port; and

enabling or disabling filtering of the importing direction media streams according to the protocol type.

The media gateway exporting direction media stream filtering rule comprises at least one of the following rules:

enabling or disabling filtering of the exporting direction media streams according to the source address;

enabling or disabling filtering of the exporting direction media streams according to the source port;

enabling or disabling filtering of the exporting direction media streams according to the destination address;

enabling or disabling filtering of the exporting direction media streams according to the destination port; and

enabling or disabling filtering of the exporting direction media streams according to the protocol type.

A relation of the combination of the respective rules is either “AND” or “OR”. A filtering mode of the combination of the rules for performing the gate control of the media stream enables or disables the media stream conforming to the combination of the filtering rules to pass or from passing.

The media stream filtering rule and the media stream source/destination address, source/destination port and protocol type information needed when performing filtering according to the media stream filtering rule are carried by Property parameters of the H.248 protocol or the MGCP protocol and sent to the media gateway by the media gateway controller.

If the gate control performed to the media stream on the media gateway fails, the media gateway returns corresponding failure information to the media gateway controller.

The failure information is sent to the media gateway controller through the Error Code of the H.248 protocol or the MGCP protocol.

In the gate control of the disclosure, the media gateway controller sends to the media gateway the gate control information for gate controlling the media streams of this media gateway, and the media gateway performs gate control to the corresponding media streams passing through the media gateway according to the gate control information, thus providing an effective solution for the media gateway controller to dynamically perform the complete gate control of the media streams on various media gateway, thereby satisfying the actual requirement on the quality of service and security of the network.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of the media gateway control of the prior art;

FIG. 2 is a schematic diagram of the media gateway controller controlling the media gateway to perform the media conversion and transfer of the prior art.

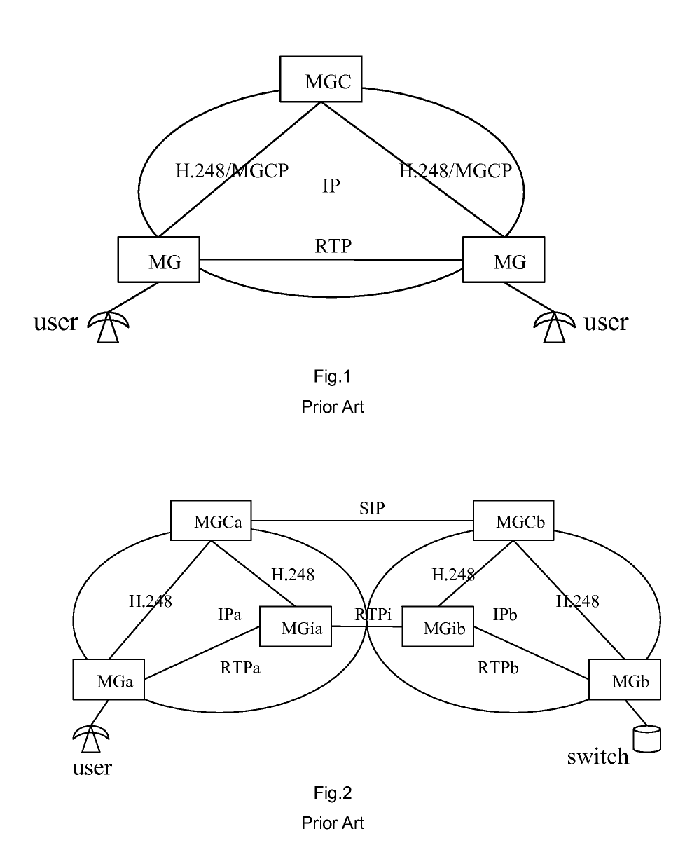

### DETAILED DESCRIPTION

The following description is merely exemplary in nature and is not intended to limit the present disclosure, application, or uses.

According to various embodiments, when gate control is performed to the media streams on the media gateway, the media gateway controller sends to the media gateway the gate control information which is used to gate control the media streams of this media gateway; the media gateway performs gate control to the corresponding media streams passing through the media gateway according to the gate control information, thus the media gateway controller is able to dynamically perform the complete gate control to the media streams on the media gateway.

To make the principle, features and merits of the disclosure clearer, the disclosure is described in details with reference to the various embodiments.

In various embodiments, the gate control method includes the following.

In Step S01, the media gateway controller sends, to the media gateway, the gate control information which is used to gate control the media streams of this media gateway.

The media gateway controller (MGC), when performing gate control to media streams on the media gateway (MG), issues the gate control information that mainly includes the media stream filtering rule which performs gate control to the media streams passing through the media gateway, and the following information that needed when performing filtering according to the media stream filtering rule: media stream source/destination address, source/destination port, and protocol type.

In step S02, the media gateway performs gate control to the corresponding media streams passing through the media gateway according to the gate control information.

The media gateway, after receiving the gate control information, may filter the corresponding media streams according to the media stream filtering rule and corresponding media stream source/destination address, source/destination port and protocol type information included in this gate control information, to perform the gate control. In various embodiments, the media stream filtering rule and the media stream source/destination address, source/destination port and the protocol type information needed when performing the filtering according to the media stream filtering rule may be carried through Property parameters of the H.248 protocol or the MGCP protocol and sent to the media gateway by the media gateway controller. Taking the H.248 protocol as a non-limiting example, the descriptors Local and Remote already existing in the H.248 protocol may, through the form of SDP, respectively provide the destination address, destination port and the protocol type of this media stream at the importing direction and the exporting direction, the Property parameters of Local may carry the destination address, destination port and the protocol type of the importing direction media stream in the media gateway, and the Property parameters of Remote may carry the destination address, destination port and the protocol type of the exporting direction media stream. In various embodiments, for the H.248 protocol it may also be extended to add Property parameters carrying the source address, source port of the importing direction media stream, and the exporting direction media stream, as well as the media stream filtering rule which perform gate control to the media stream on the media gateway.

Specifically, in the various embodiments, the three Property parameters extended in the H.248 protocol respectively represent the source address and source port of importing direction media stream, the source address and source port of exporting direction media stream, and the media stream filtering rule. It should be noted that those above Property parameters may be defined either in the existing packets or in new packets. For example, a new packet is named IP Domain Connection, and the above three Property parameters are respectively named as Importing Source Address and Port, Exporting Source Address and Port, Media Stream Filtering Rule.

In various embodiments, the Property parameter of Importing/Exporting Source Address and Port is a string, which includes the importing/exporting source address and/or the source port information, and may be structured in the form of the combination of the host name or IP address, and port. By default, any absent component may indicate an arbitrary value. In addition, for a certain component a wildcard “*” may be applied to indicate an arbitrary value, for example the Property parameter may take such values as MyHost:0909, 12.34.56.78:0909, MyHost, 12.34.56.78, :0909, 12.34.*.*, etc.

The Media Stream Filtering Rule may include the media gateway importing direction media stream filtering rule and the media gateway exporting direction media stream filtering rule. The media gateway importing direction media stream filtering rule may include any combination of the following rules:
enabling or disabling filtering of the importing direction media streams according to the source address;
enabling or disabling filtering of the importing direction media streams according to the source port;
enabling or disabling filtering of the importing direction media streams according to the destination address;
enabling or disabling filtering of the importing direction media streams according to the destination port; and
enabling or disabling filtering of the importing direction media streams according to the protocol type.

Likewise, the media gateway exporting direction media stream filtering rule may include any combination of the following rules:
enabling or disabling filtering of the exporting direction media streams according to the source address;
enabling or disabling filtering of the exporting direction media streams according to the source port;
enabling or disabling filtering of the exporting direction media streams according to the destination address;
enabling or disabling filtering of the exporting direction media streams according to the destination port; and
enabling or disabling filtering of the exporting direction media streams according to the protocol type.

The combination relation among the rules may be either “AND” or “OR”; in addition, the filtering mode applied by the rules combination for gate control of the media streams may be enabling or disabling the passing through of the media streams conforming to the filtering rule.

In various embodiments, the Property parameter of Media Stream Filtering Rule in the disclosure carrying the media stream filtering rule information may be a word with double bytes. The two bytes respectively contain the media stream filtering rule of the importing direction and the exporting direction. As to each bit in every byte, one bit represents the filtering mode (Bit7 in various embodiments), with its value of 0 meaning that only the media streams conforming to the filtering rule is allowed to pass, and its value of 1 meaning that only the media streams conforming to the filtering rule is prohibited from passing; another bit is used for representing the rule relation (Bit6 in various embodiments), with its value of 0 meaning that this direction related rules of this stream is “AND”, and its value of 1 meaning that this direction related rules of the stream is “OR”. The remaining bits indicate whether certain filtering rule are enabled, with value 0 meaning that the filtering rule is disabled and, with value 1 meaning that the filtering rule is enabled. The redundant bits may be reserved for future use. By fault this word is 0, meaning that no gate control is performed. Specifically, in various embodiments, the bits of the word may be defined as follows from low to high:

[Low Bytes]
bit0: the importing direction media streams are filtered according to the source address;
bit1: the importing direction media streams are filtered according to the source port;
bit2: the importing direction media streams are filtered according to the destination address;
bit3: the importing direction media streams are filtered according to the destination port;
bit4: the importing direction media streams are filtered according to the protocol type;
bit5: reserved;
bit6: importing direction rules relation; and
bit7: importing direction media streams filtering mode.

[High Bytes]
bit0: the exporting direction media streams are filtered according to the source address;
bit1: the exporting direction media streams are filtered according to the source port;
bit2: the exporting direction media streams are filtered according to the destination address;
bit3: the exporting direction media streams are filtered according to the destination port;
bit4: the exporting direction media streams are filtered according to the protocol type;
bit5: reserved;
bit6: exporting direction rule relation; and
bit7: exporting direction media streams filtering mode.

To describe one various embodiment, the Property parameter of Filtering Rule may take a value of 0000110011000011 in a binary form or 0CC3 in a hexadecimal form, which means that media streams whose exporting direction conforms to both condition of the designated destination address and destination port is allowed to pass, whereas the media streams whose importing direction conforms to either condition of the designated source address or source port are prohibited from passing.

It should be noted that when the Property parameter of Filtering Rule issued by the MGC is unable to be implemented by the MG due to certain reason, in other words, the gate control fails, the MG returns the corresponding failure information to the MGC. The failure information in the disclosure may be sent to the MGC through the Error Code of the H.248 protocol or the MGCP protocol. For example, if certain media stream filtering rule to be enabled in the Property parameter sent to the media gateway by the MGC is not supported by the MG, the MG returns the Error Code currently defined in the H.248 protocol, which means not supporting certain parameter or property value. If certain filtering rule to be enabled in the Property parameter by MGC lacks necessary information support (for example, to enable the filtering of the importing direction according to the source address without providing the source address), the MG returns the Error Code newly defined by the extended H.248 protocol and the Error Code newly defined indicates lack of the related information.

Based on the above extended definition, the MGC, when it is not necessary to intervene in the gate control of media streams on the MG, may not send any Property parameter of Filtering Rule, and the MG, according to the Property parameter that is 0 by default, deems that the MGC requires no gate control. When the MGC needs to manage the gate control of media streams on the MG effectively, the MGC determines, regarding respectively the importing direction and the exporting direction, the filtering rule to be used and their combination relation (AND/OR), and the filtering mode (enabling/disabling the passing through), and the MGC sets, in the Property parameter of Filtering Rule, corresponding flag bits and then sends it to the MG. Further, the MGC also needs to send to the MG the related information of the filtering rule to be used, e.g., the source address, the source port, etc., before or at the same time of issuing the Property parameter of Filtering Rule. The MG, when obtaining the gate control instructions from the MGC, extracts the media stream filtering rule and the related information that is needed when performing filtering according to the filtering rule, and filters the corresponding media streams. During this process, the MG returns the corresponding Error Code to the MGC if any problems occur that causes the gate control aborted.

The above description is merely of various embodiments of the disclosure and should not be construed as limiting the scope of the disclosure. Any modifications, equivalent alternatives, and improvements made within the principle of the disclosure shall fall into the protection scope of the claims of the disclosure.

What is claimed is:

1. A gate control method of a media gateway, comprising:
receiving gate control information for gate controlling media streams of a media gateway from a media gateway controller; and
performing gate control to the media streams passing through the media gateway according to the gate control information.

2. The gate control method of the media gateway according to claim 1, wherein the gate control information comprises a media stream filtering rule for performing gate control to the media streams passing through the media gateway, and a media stream source/destination address, a source/destination port and protocol type information needed when performing filtering according to the media stream filtering rule.

3. The gate control method of the media gateway according to claim 2, wherein the media stream filtering rule comprises a media gateway importing direction media stream filtering rule and/or a media gateway exporting direction media stream filtering rule.

4. The gate control method of the media gateway according to claim 3, wherein the media gateway importing direction media stream filtering rule comprises at least one of the following rules:
enabling or disabling filtering of the importing direction media streams according to the source address;
enabling or disabling filtering of the importing direction media streams according to the source port;
enabling or disabling filtering of the importing direction media streams according to the destination address;
enabling or disabling filtering of the importing direction media streams according to the destination port; and
enabling or disabling filtering of the importing direction media streams according to the protocol type.

5. The gate control method of the media gateway according to claim 3, wherein the media gateway exporting direction media stream filtering rule comprises at least one of the following rules:
enabling or disabling filtering of the exporting direction media streams according to the source address;
enabling or disabling filtering of the exporting direction media streams according to the source port;
enabling or disabling filtering of the exporting direction media streams according to the destination address;
enabling or disabling filtering of the exporting direction media streams according to the destination port; and
enabling or disabling filtering of the exporting direction media streams according to the protocol type.

6. The gate control method of the media gateway according to claim 4, wherein a filtering mode of the combination of the rules for performing the gate control of the media stream is to enable the media stream conforming to the combination of the filtering rules to pass or disable the media stream conforming to the combination of the filtering rules from passing.

7. The gate control method of the media gateway according to claim 5, wherein a filtering mode of the combination of the rules for performing the gate control of the media stream is to enable the media stream conforming to the combination of the filtering rules to pass or disable the media stream conforming to the combination of the filtering rules from passing.

8. The gate control method of the media gateway according to claim 2, wherein the gate control information is carried by Property parameters of the H.248 protocol or the MGCP protocol.

9. The gate control method of the media gateway according to claim 1, further comprising:
returning failure information, by the media gateway, to the media gateway controller if the gate control performed to the media stream on the media gateway fails.

10. The gate control method of the media gateway according to claim 9, wherein returning failure information to the media gateway controller comprises:
returning the failure information to the media gateway controller through the Error Code of the H.248 protocol or the MGCP protocol.

11. A system comprising a media gateway and a media gateway controller, wherein,
a media gateway controller adapted to send gate control information for gate controlling media streams; and
a media gateway adapted to receive the gate control information for gate controlling media streams from the media gateway controller and perform gate control to the media streams passing through the media gateway according to the gate control information.

12. The system according to claim 11, wherein the gate control information comprises a media stream filtering rule for performing gate control to the media streams passing through the media gateway, and a media stream source/destination address, a source/destination port and protocol type information needed when performing filtering according to the media stream filtering rule.

13. The system according to claim 12, wherein the media stream filtering rule comprises a media gateway importing direction media stream filtering rule and/or a media gateway exporting direction media stream filtering rule.

14. The system according to claim 12, wherein the gate control information is carried by Property parameters of the H.248 protocol or the MGCP protocol.

15. A media gateway configured to implement a method comprising:
receiving gate control information for gate controlling media streams of a media gateway from a media gateway controller;
performing gate control to the media streams passing through the media gateway according to the gate control information.

16. The media gateway according to claim 15, wherein the gate control information comprises a media stream filtering rule for performing gate control to the media streams passing through the media gateway, and a media stream source/destination address, a source/destination port and protocol type information needed when performing filtering according to the media stream filtering rules.

17. The media gateway according to claim 16, wherein the media stream filtering rule comprises a media gateway importing direction media stream filtering rule and/or a media gateway exporting direction media stream filtering rule.

18. The media gateway according to claim 16, wherein the gate control information is carried by Property parameters of the H.248 protocol or the MGCP protocol.
